(19) United States
(12) Patent Application Publication
(10) Pub. No.: US 2025/0377896 A1
(43) Pub. Date: Dec. 11, 2025

(54) MICROPROCESSOR AND PROCESSING METHOD OF MICROPROCESSOR

(71) Applicant: Fujitsu Limited, Kawasaki-shi (JP)

(72) Inventor: Hiroaki KIMURA, Yokohama (JP)

(73) Assignee: Fujitsu Limited, Kawasaki-shi (JP)

(21) Appl. No.: 19/301,385

(22) Filed: Aug. 15, 2025

Related U.S. Application Data
(63) Continuation of application No. PCT/JP2024/001225, filed on Jan. 18, 2024.

(30) Foreign Application Priority Data
Feb. 22, 2023 (JP) 2023-026627

(51) Int. Cl. G06F 9/38

(52) U.S. Cl. CPC G06F 9/3806; G06F 9/3844

(57) ABSTRACT

The present invention is to prevent speculative execution by a malicious program and reduce a size of a branch prediction buffer. Security IDs of several bits associated with an execution context are registered in a context table, and an instruction address executed in the past and a security ID at the time of execution are stored in a branch prediction buffer. The branch prediction mechanism searches for an entry in the branch prediction buffer with the instruction address of the branch prediction target and the security ID associated with the execution context at the time of branch prediction, and responds to an instruction address generator with a branch target address of the matching entry. The number of bits of the security ID is smaller than the number of bits of the execution context and a program ID that identifies a process included in the execution context.

### CROSS-REFERENCE TO RELATED APPLICATION

This application is a continuation of International Application No. PCT/JP2024/001225, filed on Jan. 18, 2024, now pending, herein incorporated by reference. Further, this application is based upon and claims the benefit of priority from the prior Japanese Patent Application No. 2023-026627, filed on Feb. 22, 2023, the entire contents of which are incorporated herein by reference.

### FIELD

The present invention relates to a microprocessor (arithmetic processing device) and a processing method of the microprocessor.

### BACKGROUND

A microprocessor is a semiconductor chip or an arithmetic processing device on which an arithmetic processing circuit is formed. Hereinafter, the microprocessor is abbreviated as a processor.

The microprocessor includes a circuit that speculatively executes memory access, such as a branch prediction mechanism and a prefetch controller. The branch prediction mechanism predicts a branch destination address of a branch instruction based on a branch history, prefetches the instruction of the predicted branch destination address, and speculatively executes the instruction. The prefetch controller predicts a future memory access destination, reads data of the predicted address from the main memory or the like in advance, and registers the data in the cache.

Describing the branch prediction mechanism, the processor executes processing in order of instructions of the program. Then, when the branch instruction (conditional branch, indirect branch, or the like) is executed, the branch destination address is determined according to whether or not the condition of the conditional branch is satisfied, and the branch destination of the indirect branch is determined according to the branch destination address in the register of the indirect branch. In any branch instruction, an instruction address of the branch destination is not determined unless the processing of the preceding instructions with respect to the branch instruction are completed. In order to eliminate waste due to this waiting time, the branch prediction mechanism predicts, for the address of the instruction to be fetched from the memory, whether or not the instruction of the address is a branch instruction, whether or not the branch instruction branches, where the branch destination address is, and the like, and speculatively executes the instruction following the branch destination.

Describing the prefetch controller, in a case where the processor continuously accesses data, when a cache miss occurs in the primary cache, it is necessary to access the lower cache or the main memory to read the data. In a case where data is read from the lower cache or the main memory, the latency is long, and thus the waiting time is wasted. Therefore, when a cache miss occurs in the primary cache by executing the memory access, the prefetch controller stores the address, determines the direction of the address of the memory access based on the address of the following memory access, and thereby predicts the address of the following memory access. Then, when data is prefetched at the predicted address, the prefetched data is stored in the primary cache. Therefore, when a memory access occurs for prefetched data thereafter, a cache hit is reliably made in the primary cache, and the data can be fetched in a short time.

On the other hand, according to Non-Patent Literature 1, speculative execution by a processor has a risk that confidential data is stolen by a malicious third party. That is, even an instruction that is not executed by the original program is speculatively executed by the branch prediction mechanism or the prefetch mechanism. Therefore, secret data originally prohibited from being accessed is read by the load instruction speculatively executed, and when speculatively executing the load instruction with the read secret data as an address, the load data is stored in the address of the secret data in the cache memory. Thereafter, when the cache memory is scanned, the secret data is found due to the short latency to the address of the secret data.

Patent Literature 1 describes, as a measure against the vulnerability of the above-described processor, that a context or program identification information (program ID) included in the context are included in branch history information of each entry of a buffer in a branch prediction mechanism, and branch prediction is performed based on branch history information corresponding to the context of a process being executed or the program ID. The context is parameter information associated with a process of a program being executed. As a result, the branch prediction based on the branch history information left by the program being executed is permitted, and the instruction of the branch target address of the branch history left by the malicious third party program is prevented from being speculatively executed.

### CITATION LIST

### Patent Literature

Patent Literature 1: JP 2021-516384 A
Patent Literature 2: JP 2021-524621 A

### Non-Patent Literature

Non-Patent Literature 1: https://googleprojectzero.blogspot.jp/2018/01/reading-privileged-memory-with-side.html?m=1

### SUMMARY

However, the context or the program ID included in the context itself has a long bit length. The number of bits of the context is, for example, 100 bits or more, and the number of bits of the program ID is, for example, 16 bits or more. On the other hand, the number of entries of the branch prediction buffer in the branch prediction mechanism is usually on the order of several hundreds to several thousands. Therefore, if the context or the program ID are included in the branch history information of each entry of the buffer in the branch prediction mechanism, the circuit scale of the branch prediction mechanism becomes enormous, leading to an increase in the area and power of the processor. The prefetch mechanism has a similar problem.

The object and advantages of the invention will be realized and attained by means of the elements and combinations particularly pointed out in the claims.

It is to be understood that both the foregoing general description and the following detailed description are exemplary and explanatory and are not restrictive of the invention.

### Means for Solving the Problems

According to an aspect of the embodiments, a microprocessor includes an instruction address generator that generates an instruction address that is a fetch destination of an instruction and outputs the instruction address to execute an instruction fetch; a context table that includes a context buffer including M first entries that respectively store an execution context associated with a process in association with a security ID capable of identifying the execution context, and extracts the security ID associated with the execution context of the process being executed; and a branch prediction mechanism that includes a branch prediction buffer including N second entries that respectively store a tag that stores a branch instruction address of a branch instruction executed in the past and the security ID when the branch instruction was executed, and a branch target address of the branch instruction executed in the past; N being greater than M, and M and N being natural numbers greater than or equal to 2, the branch prediction mechanism comparing the instruction address output by the instruction address generator and the security ID extracted from the context table with the branch instruction address and the security ID in the tag of the N second entries, and outputting the branch target address in the N second entries matched in the comparison to the instruction address generator, wherein the instruction address generator executes the instruction fetch based on the branch target address output from the branch prediction mechanism.

### BRIEF DESCRIPTION OF DRAWINGS

FIG. 1 is a diagram illustrating a configuration example of a core of a processor.

FIG. 2 is a diagram illustrating an example of a branch prediction buffer in a branch prediction mechanism.

FIG. 3 is a diagram illustrating a configuration example of a core of a processor according to a first embodiment.

FIG. 4 is a diagram illustrating a first configuration example of the context table 26 in the present embodiment.

FIG. 5 is a diagram illustrating a configuration example of the branch prediction mechanism 24 in the present embodiment.

FIG. 6 is a diagram illustrating an example of the branch prediction buffer BR_PRD_BUF in the branch prediction mechanism.

FIG. 7 is a diagram illustrating a configuration of a context table in a modification of the first embodiment.

FIG. 8 is a diagram illustrating a configuration example of a core of a processor according to a second embodiment.

FIG. 9 is a diagram illustrating a first configuration example of the context table in the second embodiment.

FIG. 10 is a diagram illustrating a configuration example of a branch prediction mechanism in the second embodiment.

FIG. 11 is a diagram illustrating a modification of the context table in the second embodiment.

FIG. 12 is a diagram illustrating a configuration of a core of a processor according to a third embodiment.

FIG. 13 is a diagram illustrating a configuration example of the prefetch controller 32 according to the present embodiment.

FIG. 14 is a diagram illustrating a flowchart example of the operation of the context table.

FIG. 15 is a diagram illustrating a first example of a context table and a TAG of a branch prediction mechanism having a security problem.

FIG. 16 is a diagram illustrating a second example of the context table and the TAG of the branch prediction mechanism having a security problem.

### DESCRIPTION OF EMBODIMENTS

### Definition of Terms

Process: A program being executed.

Execution context: Information associated with a process, and a collection of parameters, such as an identifier that identifies a process, an identifier that identifies a virtual machine, and an identifier that identifies a privilege level.

Program ID: Corresponds to the process identifier in the execution context. The bit length is as long as 16 bits or more.

Security ID: An identifier associated with the execution context. An identifier capable of identifying a process similarly to an execution context or a program ID. The number of bits is smaller than the execution context and the program ID. For example, the number of bits is several bits.

### First Embodiment

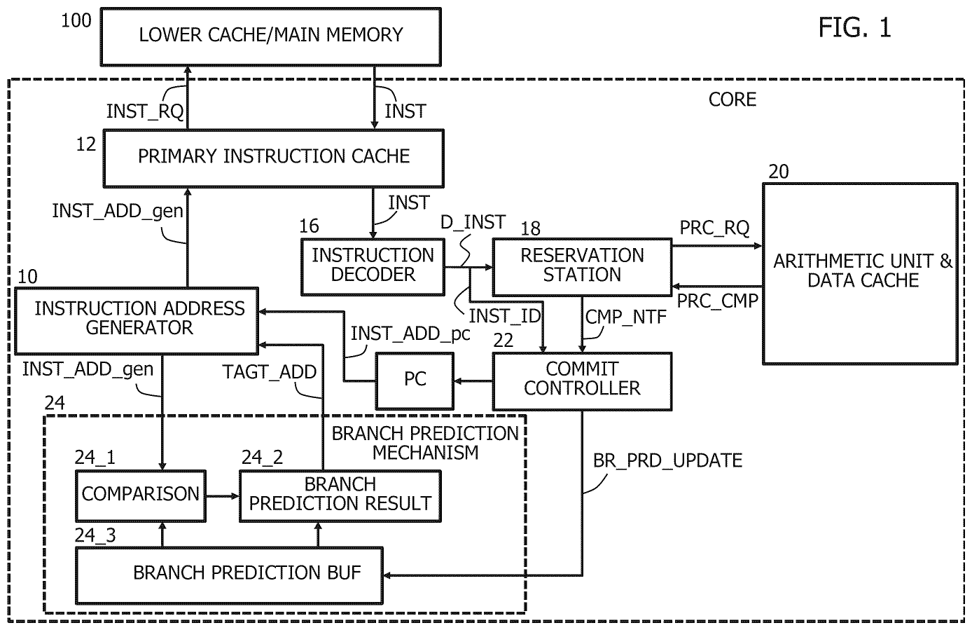

FIG. 1 is a diagram illustrating a configuration example of a core of a processor. In general, a processor includes a plurality of cores, a lower cache shared by the plurality of cores, a memory access controller that accesses a main memory, an interface with the outside of a processor chip, and the like. A core CORE illustrated in FIG. 1 includes an instruction address generator 10, a primary instruction cache 12, an instruction decoder 16, a reservation station 18, an arithmetic unit 20, a commit controller 22, a program counter PC, a branch prediction mechanism 24, and the like except for a lower cache and a main memory 100. The arithmetic unit 20 includes an arithmetic circuit and a data cache. Among the lower cache and the main memory 100 not included in the core, the lower cache is provided in the processor chip outside the core, and the main memory is provided outside the processor chip.

The instruction address generator 10 generates an instruction address to be fetched, and fetches an instruction at a generated instruction address INST_ADD_gen. The instruction address generator 10 sends a memory access request to fetch an instruction to the primary instruction cache 12, and searches the primary instruction cache using the instruction address. If a cache hit occurs, an instruction INST in the primary instruction cache 12 is responded to the instruction decoder 16. If a cache miss occurs, the primary instruction cache 12 transmits a memory access request to the lower cache 100 or to the external main memory 100 via a memory access controller (not illustrated). The instruction INST read in response to the memory access request is returned to the instruction decoder 16.

The instruction decoder 16 decodes the received instruction INST in the order of the program, transmits a decoded instruction D_INST to the reservation station 18, and transmits an instruction identifier INST_ID indicating the order of the instruction INST to the commit controller 22. The instruction D_INST stored in the input queue of the reservation station is executed in an out-of-order manner by sending a processing request PRC_RQ of the instruction to the arithmetic unit 20 in order of completion of calculation preparation.

When the processing is ended, the arithmetic unit 20 returns a processing completion PRC_CMP to the reservation station 18, and a completion notification CMP_NTF together with the instruction identifier is sent to the commit controller 22. The commit controller 22 completes the processed instructions in the order of the instruction of the program and updates the resource used for the processing of the instruction. When the process is completed for the branch instruction, the commit controller 22 sends the instruction address, success or failure of the branch, and the branch destination address to the branch prediction mechanism 24 as the branch history information. The branch prediction mechanism 24 stores the received branch history information in a branch prediction buffer 24_3.

Next, instruction address generation processing of the instruction address generator 10 will be described. The instruction address generator 10 selects an instruction address to be fetched next from instruction address INST_ADD_pc in the program counter PC, a target address TAGT_ADD predicted by the branch prediction mechanism 24, and the like, and executes the instruction fetch in the primary instruction cache 12.

Assuming that the order of a certain program is an instruction A and a branch instruction X, a start address of the instruction A which is a start instruction of the program is stored in the program counter PC. The instruction address generator 10 issues an instruction fetch request (instruction read request) to the primary instruction cache 12 using the instruction address INST_ADD_pc in the PC as fetch address INST_ADD_gen. In parallel with the issuance of the instruction fetch request, the instruction address generator 10 sends the fetch address INST_ADD_gen to the branch prediction mechanism 24.

In the branch prediction mechanism 24, a comparator 24_1 searches for the instruction address of the branch history stored in the branch prediction buffer 24_3 at the received fetch address INST_ADD_gen, and a branch prediction result generator 24_2 transmits the branch prediction result (including branch hit/miss and branch target address) to the instruction address generator 10 based on the branch target address TAGT_ADD in the entry in the branch prediction buffer 24_3 that stores the instruction address matched with the fetch address. In response to this, the instruction address generator 10 selects either the instruction address following the fetch address INST_ADD_gen in the PC or the branch target address TAGT_ADD included in the branch prediction result based on the branch prediction result, and issues an instruction fetch. Since the instruction A is not a branch instruction, the branch prediction result is a branch miss, and the instruction address generator 10 selects the instruction address (the instruction address INST_ADD_pc of the PC) of the instruction X following the instruction A and fetches the instruction.

When issuing an instruction fetch at the instruction address of the branch instruction X, the instruction address generator 10 sends the instruction address INST_ADD_gen to the branch prediction mechanism 24. When receiving the instruction address of the branch instruction X, the branch prediction mechanism 24 transmits a branch prediction result that results in a branch hit in the branch prediction buffer 24_3 and having a branch presence flag and branch target address to the instruction address generator 10. The instruction address generator 10 selects the branch target address this time, and performs an instruction fetch to the primary instruction cache 12 based on the branch target address.

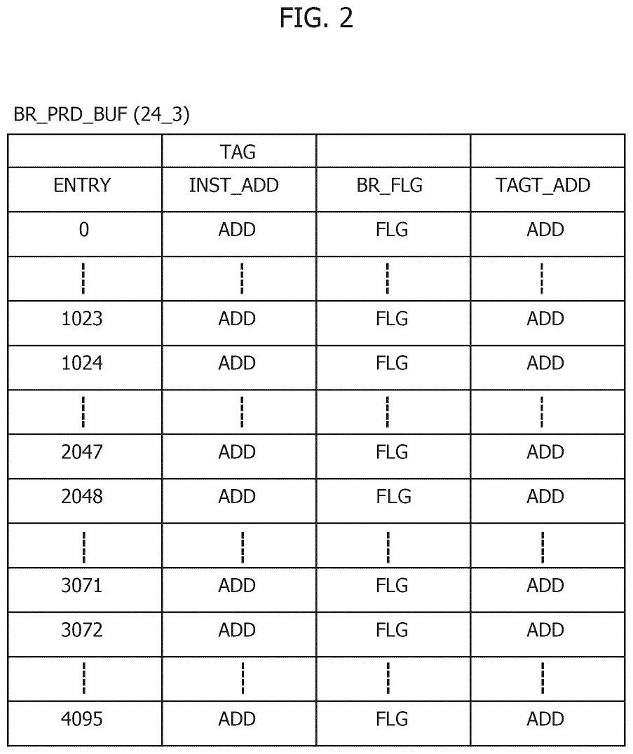

FIG. 2 is a diagram illustrating an example of a branch prediction buffer in a branch prediction mechanism. In the example of a branch prediction buffer BR_PRD_BUF in FIG. 2, the number of entries is 4096 entries (entry numbers 0 to 4095). Each entry ENTRY stores, as a branch history, a tag TAG in which instruction address INST_ADD of a branch instruction executed in the past is stored, a branch flag BR_FLG indicating a type of a branch instruction, and a branch target address TAGT_ADD indicating a branch destination address of a branch instruction executed in the past. The number of entries 4096 is an example, and a normal processor has several hundreds to several thousands of entries. In addition, the valid bit for each entry is omitted.

The branch prediction mechanism 24 searches the tag of the entry in the branch prediction buffer, the comparator 24_1 compares the fetch address INST_ADD_gen sent from the instruction address generator with the instruction address INST_ADD in the tag, and detects an entry storing matching instruction address in the comparison. Then, the branch prediction result generator 24_2 transmits the branch target address TAGT_ADD in the detected entry to the instruction address generator 10 together with the branch match information.

According to Non-Patent Literature 1, in a case where a malicious program registers an address of a load instruction for loading secret data as a malicious fake branch history in the branch target address TAGT_ADD in an entry in a branch prediction buffer, a load instruction to the secret data is speculatively executed during normal program execution. Even when the address of the secret data is at the privilege level, the secret data is read by the load instruction that has been speculatively executed.

Patent Literature 1 describes that an execution context or program identification information (program ID) associated with a process that is a program being executed is stored in a tag of a branch prediction buffer in FIG. 2, and an entry belonging to an authorized program is isolated from an entry belonging to a malicious program.

However, since the number of bits of the execution context and the program identification information is usually as large as several tens to several hundreds of bits, if the execution context and the program ID are stored in several thousands of entries of the branch prediction buffer in the branch prediction mechanism, the circuit scale of the branch prediction mechanism becomes enormous, which is not preferable.

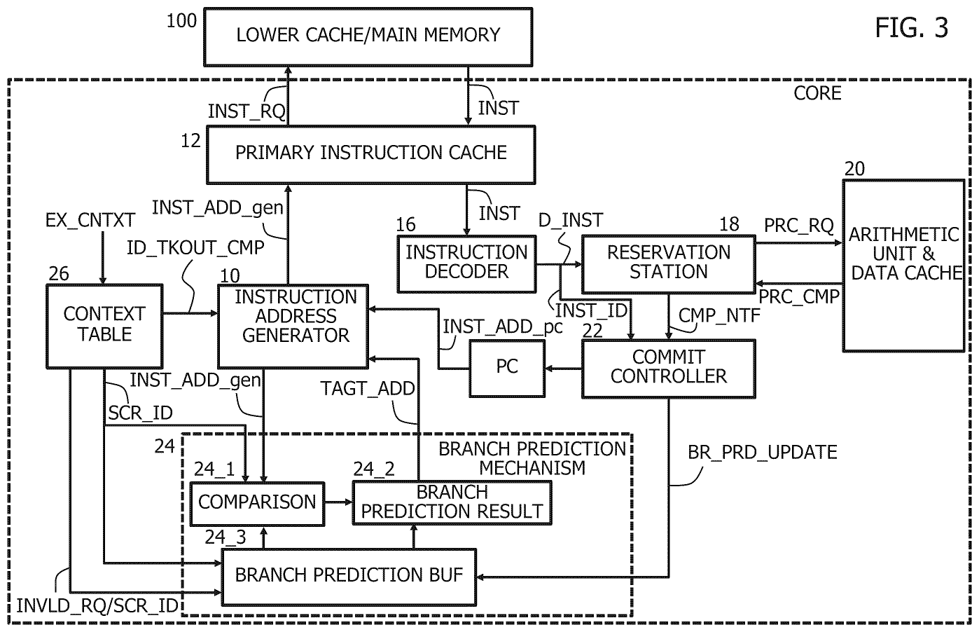

FIG. 3 is a diagram illustrating a configuration example of a core of a processor according to a first embodiment. Similarly to the configuration example of the core in FIG. 1, the core in FIG. 3 includes an instruction address generator 10, a primary instruction cache 12, an instruction decoder 16, a reservation station 18, an arithmetic unit 20, a commit controller 22, a program counter PC, a branch prediction mechanism 24, and the like.

Unlike the core of FIG. 1, the core of FIG. 3 has a context table processor (hereinafter, referred to as a context table for simplicity) 26. The context table 26 stores an execution context EX_CNTXT and a security ID that is associated with the execution context and can identify the execution context. The execution context and the security ID are as in the foregoing definition. Furthermore, in the core of FIG. 3, each entry in the branch prediction buffer 24_3 in the branch prediction mechanism 24 stores a security ID in addition to instruction address as tag information. Then, the comparator 24_1 compares the fetch address INST_ADD_gen of the instruction from the instruction address generator 10 and the security ID (SCR_ID) from the context table 26 with the instruction address and the security ID of each entry in the branch prediction buffer 243, and searches for a matching entry.

A schematic operation of the core of FIG. 3 will be described. When execution of a certain program is started, the execution context EX_CNTXT of the program whose execution has started is output from the system. The context table 26 registers the execution context EX_CNTXT in an empty entry in the context table in association with the security ID, extracts (outputs) the security ID associated with the execution context EX_CNTXT, and outputs a security ID extraction completion flag ID_TKOUT_CMP to the instruction address generator 10. The security ID extraction completion flag is a kind of valid bit of the output security ID.

When the extraction completion flag ID_TKOUT_CMP is true (completed), the instruction address generator 10 sends the fetch address INST_ADD_gen of the instruction to the branch prediction mechanism 24, and the branch prediction mechanism 24 searches the tag in the branch prediction buffer 243 using the fetch address INST_ADD_gen and the security ID (SCR_ID), and determines whether there is a matching entry. Since the security ID at that time is stored in the tag of the entry in the branch prediction buffer in addition to the branch instruction address executed in the past, the entry of the branch history of the currently executed program can be distinguished from the entry of the branch history of the malicious program.

Since the security ID is, for example, several bits and is much smaller than the number of bits (several tens to several hundreds of bits) of the execution context and the program ID, an increase in the circuit scale of the branch prediction buffer in the branch prediction mechanism can be suppressed.

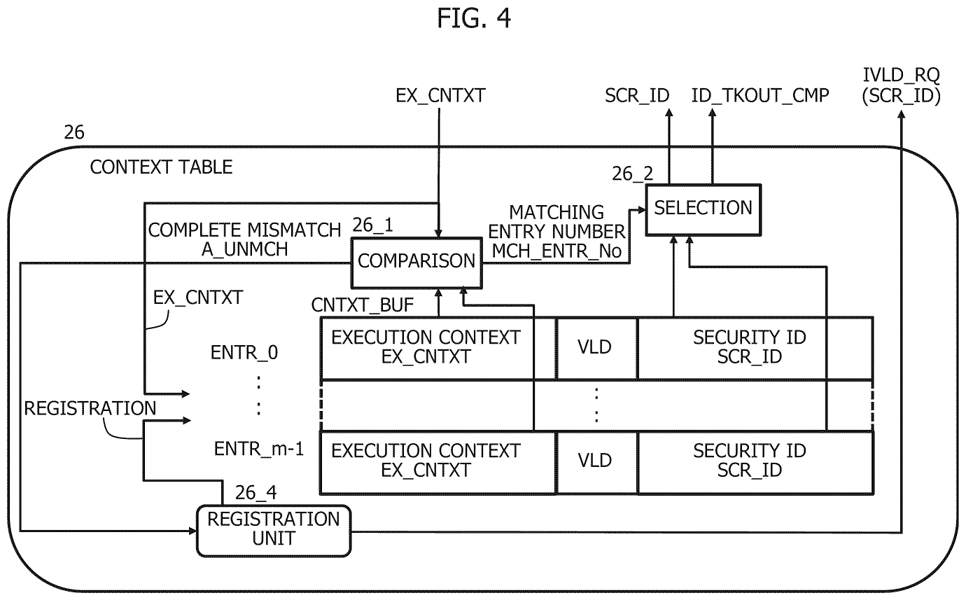

FIG. 4 is a diagram illustrating a first configuration example of the context table 26 in the present embodiment. The context table 26 includes a comparator 261, a selection circuit 262, and a context buffer CNTXT_BUF. The context buffer CNTXT_BUF has a plurality of entries ENTR_0 to ENTR_m-1 that respectively store an execution context EX_CNTXT, a security ID (SCR_ID) associated with the execution context EX_CNTXT, and a valid bit VLD. The number of entries M in the context buffer CNTXT_BUF is a number based on the number of bits of the security ID. For example, in a case where the security ID is 2 bits, it is desirable that the number of entries M be 2²=4 at the maximum.

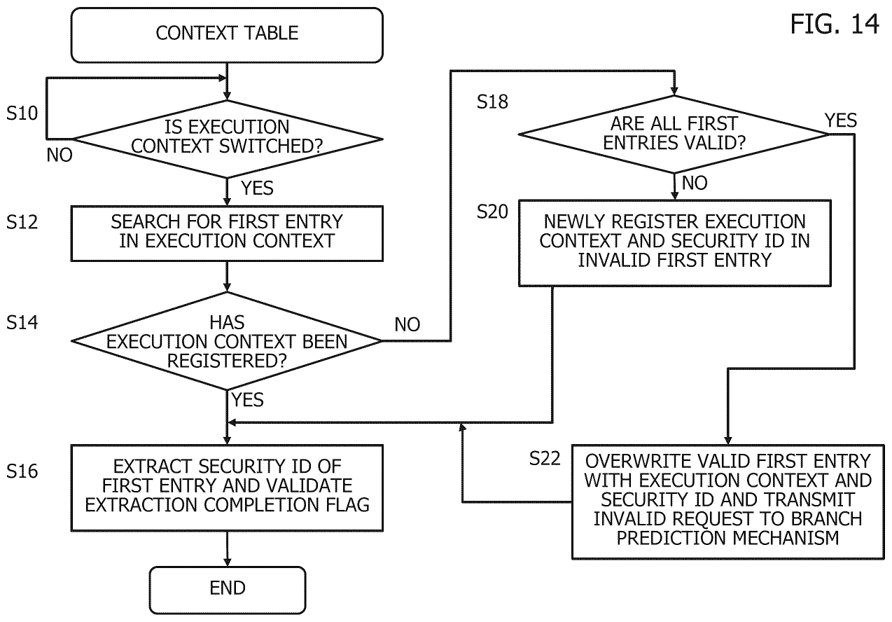

FIG. 14 is a diagram illustrating a flowchart example of the operation of the context table. When execution of a certain program is started and the execution context EX_CNTXT is switched (YES in S10), the context table 26 searches for an entry in the context buffer CNTXT_BUF with the execution context EX_CNTXT after switching (S12). The comparator 26_1 compares the execution context EX_CNTXT after switching with the execution context EX_CNTXT in each entry in the context buffer CNTXT_BUF, and outputs a matching entry number MCH_ENTR_No when there is a matching entry. In this case, the execution context has already been registered in the context buffer (YES in S14). Therefore, the selection circuit 26_2 extracts (outputs) the security ID (SCR_ID) of the matching entry number, and sets the security ID extraction completion flag ID_TKOUT_CMP to true (completion) (S16). As a result, the extracted security ID becomes the security ID associated with the current execution context.

In a case where there is no entry in the context buffer in which the execution context matching the execution context EX_CNTXT is stored, and the valid bit is true (valid), the comparator outputs a complete mismatch A_UNMCH to a registration unit 26_4. In this case, the execution context is not registered in the context buffer (NO in S14). In response to the complete mismatch A_UNMCH, when there is an invalid entry (NO in S18), the registration unit 26_4 newly registers the execution context EX_CNTXT after switching and the security ID that can identify the execution context EX_CNTXT in the invalid entry in the context buffer, and changes the valid bit VLD of the registered entry to true (valid) (S20). At the same time, the selection circuit 26_2 outputs the security ID, and sets the security ID extraction completion flag ID_TKOUT_CMP to true (completion) (S16).

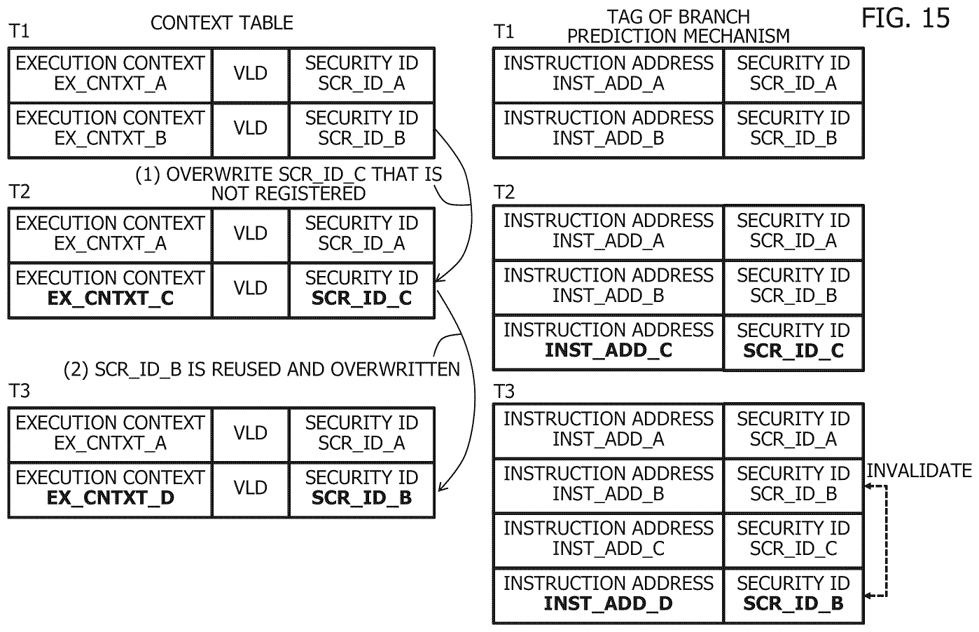

When the valid bits VLD of all the entries of the context table are true (valid) at the time of newly registering the execution context after the switching (YES in S18), the registration unit 26_4 overwrites one of the existing valid entries with the execution context after the switching and the security ID associated with the execution context (S22). At this time, if the security ID before overwriting is then registered again in the context table as a security ID associated with a different execution context, there is a possibility that the branch prediction mechanism cannot distinguish the entry of the branch history of the program currently being executed from the entry of the branch history of the malicious program, and there is a security problem. This security problem will be described later with reference to FIG. 15.

Therefore, the registration unit 26_4 outputs an invalid request INV_RQ having the security ID before overwriting to the branch prediction mechanism 24 (S22). In response to the invalid request INV_RQ, the branch prediction mechanism 24 invalidates an entry in the branch prediction buffer BR_PRD_BUF that stores at least the same security ID as the security ID before overwriting. The branch prediction mechanism may invalidate all entries in response to the invalid request. Thereafter, the selection circuit 26_2 outputs the security ID and sets the security ID extraction completion flag to true (completion) (S16).

By setting the security ID to several bits, the switched execution context and the security ID are frequently overwritten in the context table. Since the security ID is several bits, the security IDs before and after overwriting may match, therefore the entry of the branch prediction mechanism described above needs to be invalidated. The invalidate request will be described in detail in the description of the branch prediction mechanism.

FIG. 15 is a diagram illustrating a first example of a context table and a TAG of a branch prediction mechanism having a security problem. FIG. 15 illustrates transitions of states at times T1, T2, and T3. At time T1, security IDs SCR_ID_A and SCR_ID_B are registered in the context table in association with execution contexts EX_CNTXT_A and EX_CNTXT_B, respectively. An example of the TAG of the branch prediction mechanism at time T1 is as illustrated.

Next, it is assumed that the execution context is changed to EX_CNTXT_C at time T2, and SCR_ID_C with the security ID that is not being registered is overwritten on the entry of SCR_ID_B that is being registered. As a result, INST_ADD_C/SCR_ID_C is assumed to be newly recorded as the instruction address/security ID in the entry of the TAG of the branch prediction mechanism. In this state, the security ID (SCR_ID_B) different from SCR_ID_C of the security ID associated with the execution context EX_CNTXT_C is not hit.

However, at time T3, the execution context may be changed to EX_CNTXT_D, and the security ID (SCR_ID_B) that is not registered at time T2 but is registered at time T1 may be overwritten on the entry of SCR_ID_C registered at time T2. That is, the security ID (SCR_ID_B) is reused. The reason is that since the number of bits of the security ID is small, the same security ID (SCR_ID_B) is frequently reused.

As a result, INST_ADD_D/SCR_ID_B is newly recorded as the instruction address/security ID in the entry of the TAG of the branch prediction mechanism at time T3, and the security ID becomes the same as INST_ADD_B/SCR_ID_B of another entry of the TAG, and a security problem occurs.

Therefore, when SCR_ID_C of the security ID not registered at time T2 is overwritten on the entry of SCR_ID_B being registered, it is necessary to invalidate the entry of INST_ADD_B/SCR_ID_B from the TAG of the branch prediction mechanism.

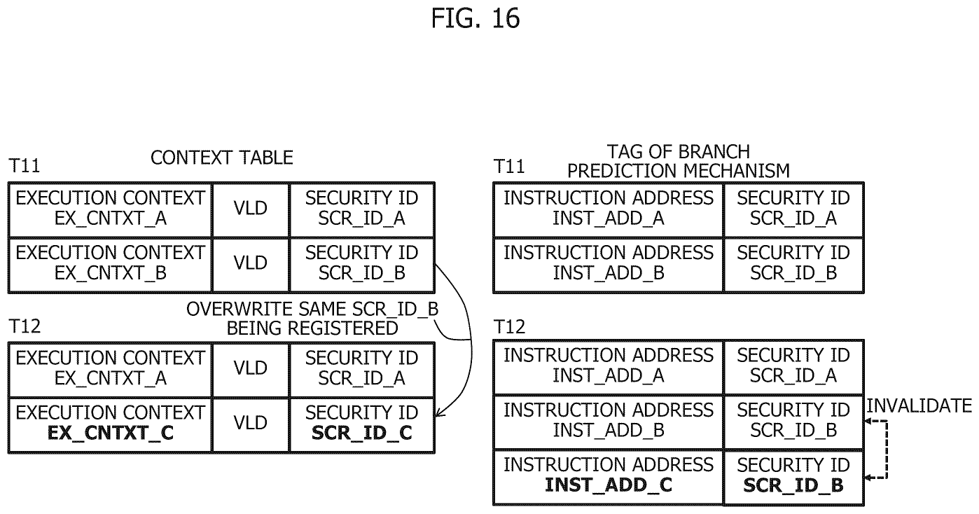

FIG. 16 is a diagram illustrating a second example of the context table and the TAG of the branch prediction mechanism having a security problem. FIG. 16 illustrates transitions of states at times T11 and T12. At time T11, the security IDs SCR_ID_A and SCR_ID_B are registered in the context table in association with the execution contexts EX_CNTXT_A and EX_CNTXT_B, respectively. An example of the TAG of the branch prediction mechanism at time T11 is as illustrated.

Next, it is assumed that the execution context is changed to EX_CNTXT_C at time T12, and the entry of SCR_ID_B being registered at time T11 is overwritten with the same security ID (SCR_ID_B). As a result, INST_ADD_C/SCR_ID_B is assumed to be newly recorded as the instruction address/security ID in the entry of the TAG of the branch prediction mechanism. In this state, since the security ID (SCR_ID_B) associated with the execution context EX_CNTXT_C and the security ID (SCR_ID_B) associated with the execution context EX_CNTXT_B are doubly registered in the TAG of the branch prediction mechanism at time T12, there is a security problem.

Therefore, also in this case, when the security ID (SCR_ID_B) is overwritten on the entry of the same security ID (SCR_ID_B) in the context table at time T12, it is necessary to invalidate the entry of the security ID (SCR_ID_B) in the TAG of the branch prediction mechanism. That is, it is necessary to invalidate the entry of the security ID to be overwritten in the TAG of the branch prediction mechanism in both cases where the security ID overwritten on a certain entry in the context table matches the security ID of the entry to be overwritten and does not match the security ID of the entry to be overwritten.

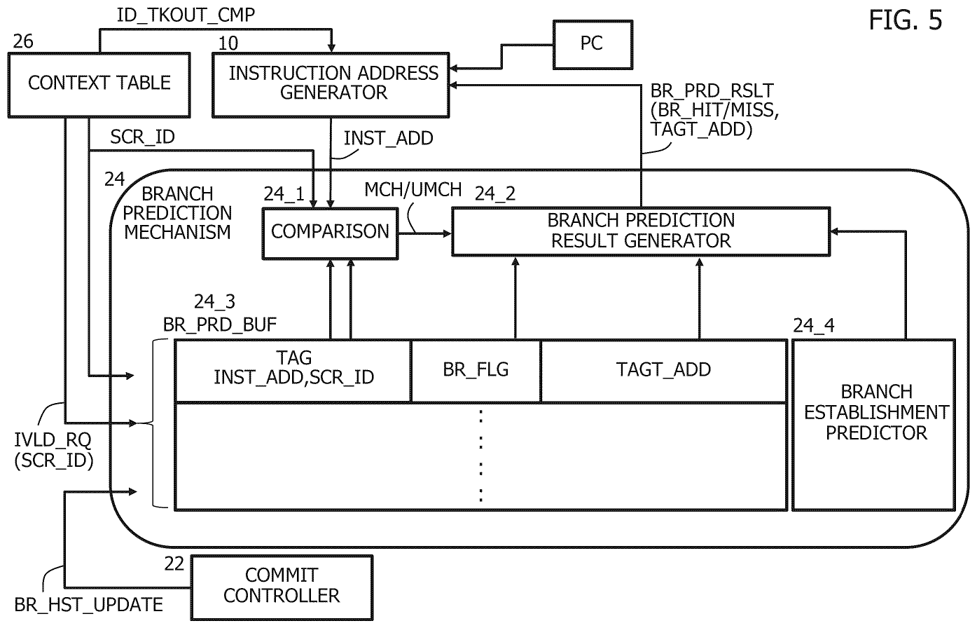

FIG. 5 is a diagram illustrating a configuration example of the branch prediction mechanism 24 in the present embodiment. The branch prediction mechanism 24 includes a comparator 241, a branch prediction result generator 242, a branch prediction buffer 243 (BR_PRD_BUF), and a branch establishment predictor 24_4. As described in FIG. 2, the branch prediction buffer 24_3 has several hundreds to several thousands of entries, and each entry stores instruction address (or a part thereof) INST_ADD of a branch instruction executed in the past in the tag TAG and a security ID (SCR_ID) associated with an execution context when the branch instruction is executed. Further, as described in FIG. 2, each entry stores the branch flag BR_FL and the target address TAGT_ADD which is the branch destination address.

When execution of the branch instruction is completed, in response to the completion notification CMP_NTF sent from the reservation station 18, the commit controller 22 transmits a branch history update request BR_HST_UPDATE to the branch prediction mechanism 24 together with the branch history of the branch instruction (instruction address, branch flag, target address, success or failure of branch, and the like). In response to the branch history update request, the branch history information and the security ID are registered in an empty entry of the branch prediction buffer 24_3 (BR_PRD_BUF) in the branch prediction mechanism.

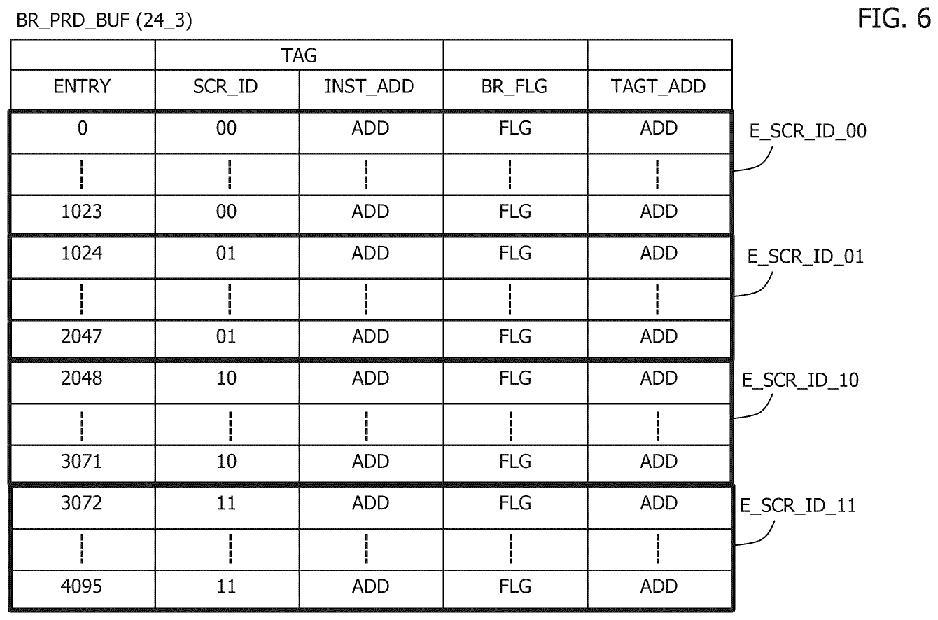

FIG. 6 is a diagram illustrating an example of the branch prediction buffer BR_PRD_BUF in the branch prediction mechanism. To compare with FIG. 2, the branch prediction buffer of FIG. 6 also has the 4096 entries same as FIG. 2. The difference from FIG. 2 is that instruction address (or a part thereof) INST_ADD of a branch instruction executed in the past and a security ID (SCR_ID) associated with an execution context when the branch instruction is executed are stored in the tag TAG of each entry. Note that each entry stores a valid bit, but is omitted in FIG. 6.

In the branch prediction buffer illustrated in FIG. 6, 4096 entries are arranged in ascending order of 2-bit security IDs. As an example, 1024 entries E_SCR_ID_00 with security ID=00, 1024 entries E_SCR_ID_01 with security ID=01, 1024 entries E_SCR_ID_10 with security ID=10, and 1024 entries E_SCR_ID_11 with security ID=11 are arranged. That is, the branch history (instruction address INST_ADD, branch flag BR_FLG indicating instruction type, target address TAGT_ADD) of the branch instruction executed in the past in the program of the execution context associated with each security ID is stored in 1024 entries for each of the four types of security IDs.

In the actual branch prediction buffer, the number of branch histories of the branch instructions of the plurality of executed programs is different, and the number of entries in which the branch histories are registered is different for each security ID. In FIG. 6, as an example, the number of entries in which the branch histories are registered is the same 1024 for each of the four security IDs.

In each of the M entries of the context table of FIG. 4, the execution contexts of the latest M execution programs are stored in association with the M security IDs. Correspondingly, the entry in the branch prediction buffer BR_PRD_BUF in FIGS. 5 and 6 stores a branch history of branch instructions in the execution program associated with the latest M security IDs.

Operations of the context table 26, the instruction address generator 10, and the branch prediction mechanism 24 illustrated in FIG. 5 will be described below. When the context table 26 can extract (output) the security ID after (1) the execution context EX_CNTXT that has been switched is not newly registered because of being registered, (2) the execution context EX_CNTXT is newly registered in an invalid entry because of being unregistered, or (3) the execution context EX_CNTXT is overwritten in a valid entry because of being unregistered, the context table 26 outputs a valid security ID extraction completion flag ID_TKOUT_CMP to the instruction address generator 10. In response to the valid extraction completion, the instruction address generator 10 starts the operation.

The instruction address generator 10 issues an instruction fetch to the primary instruction cache with the generated instruction address INST_ADD_gen, and also sends the generated instruction address (or a part thereof) INST_ADD_gen to the branch prediction mechanism 24 to cause the branch prediction mechanism 24 to predict the instruction address to be executed next. At this time, the security ID extracted from the context table 26 and registered in association with the execution context is also sent to the branch prediction mechanism 24.

The comparator 24_1 in the branch prediction mechanism compares the sent instruction address (or a part thereof) and security ID with the instruction addresses (or a part thereof) and security IDs of the tag parts of all entries in the branch prediction buffer, does not perform branch prediction in the case of a mismatch UMCH, and the branch prediction result generator 24_2 returns a branch prediction result BR_PRD_RSLT of a branch miss BR_MISS to the instruction address generator 10.

On the other hand, in a case of a match MCH in any one of the entries, the branch prediction result generator 24_2 returns a branch prediction result BR_PRD_RSLT(branch hit or miss, including target address TAGT_ADD) to the instruction address generator 10 based on the match MCH from the comparator, the branch establishment prediction from the branch establishment predictor 244, and the like. Then, the instruction address generator 10 generates instruction address to be executed next based on the branch prediction result and executes instruction fetch.

Note that the type of the branch instruction of the branch flag BR_FLG is conditional branch, indirect branch, or the like. The branch flag BR_FLG is used, for example, to check the type of the branch instruction after the instruction decoder 16 decodes the fetched branch instruction.

As described above, in the context table 26, when the valid bits VLD of all the entries of the context table are true (valid) at the time of newly registering the execution context after switching of the executing program, the registration unit 26_4 overwrites any of the existing valid entries with the execution context after switching and the security ID associated therewith. As described with reference to FIG. 15, when the security ID before overwriting is then registered again in the context table as the security ID associated with a different execution context, there is a possibility that in the branch prediction mechanism, the entry of the branch history of the program currently being executed cannot be distinguished from the entry of the branch history of the malicious program. In addition, as described with reference to FIG. 16, when the security ID to be overwritten in the entry is the same as the security ID of the entry to be overwritten, there is naturally a similar security problem.

Therefore, when the valid bits VLD of all the entries of the context table are true (valid) at the time of new registration, the registration unit 26_4 in the context table sends the invalid request INV_RQ including the security ID before overwriting to the branch prediction mechanism 24. In response to an invalidation request IVLD_RQ, the branch prediction mechanism 24 invalidates at least an entry in the branch prediction buffer BR_PRD_BUF that stores the security ID before overwriting. Alternatively, the branch prediction mechanism 24 may invalidate all entries in the branch prediction buffer. After completing the invalidation of the entry of the branch prediction mechanism 24, the branch prediction mechanism starts instruction address prediction processing. As a result, it is possible to prevent the branch prediction mechanism from responding the target address of the branch destination to the instruction address generator as the branch prediction result based on the branch history registered by the malicious program.

On the other hand, when newly registering the execution context after switching, the registration unit 26_4 in the context table 26 generates the security ID associated with the execution context. The registration unit may generate the security IDs in ascending order or descending order, or may randomly generate the security IDs.

In the case where the security IDs are generated in ascending order, for example, the security IDs are generated in 2 bits such as 00, 01, 10, and 11, the security ID to be overwritten is not matched with the security ID before the overwriting while the security ID goes one round. Therefore, the registration unit 26_4 sends an invalidation request to the branch prediction mechanism 24 only when the security ID goes one round and generates 00 again. In this case, in response to the invalidation request, the branch prediction mechanism invalidates all entries in the branch prediction buffer. As a result, the frequency of the invalidation process decreases.

In addition, in a case where the security ID is randomly generated, the registration unit does not assign the security ID being registered in the context table to the security ID to be newly generated. If the security ID being registered in the context table is allocated to the security ID to be newly generated, the registration unit needs to perform overwriting registration to the entry of the security ID being registered in the context table so that a plurality of entries in which the same security ID is associated with different execution contexts do not exist in the context table.

However, as described with reference to FIG. 16, in a case where the execution context and the security ID described above are overwritten on the valid entry that has being registered with the same security ID, the registration unit 26_4 sends an invalidation request IVLD_RQ having the security ID before being overwritten to the branch prediction mechanism 24. In this case, in response to the invalidation request IVLD_RQ, the branch prediction mechanism 24 invalidates the entry storing the security ID before overwriting in the branch prediction buffer BR_PRD_BUF, or invalidates all entries in the branch prediction buffer BR_PRD_BUF.

### Modification of First Embodiment

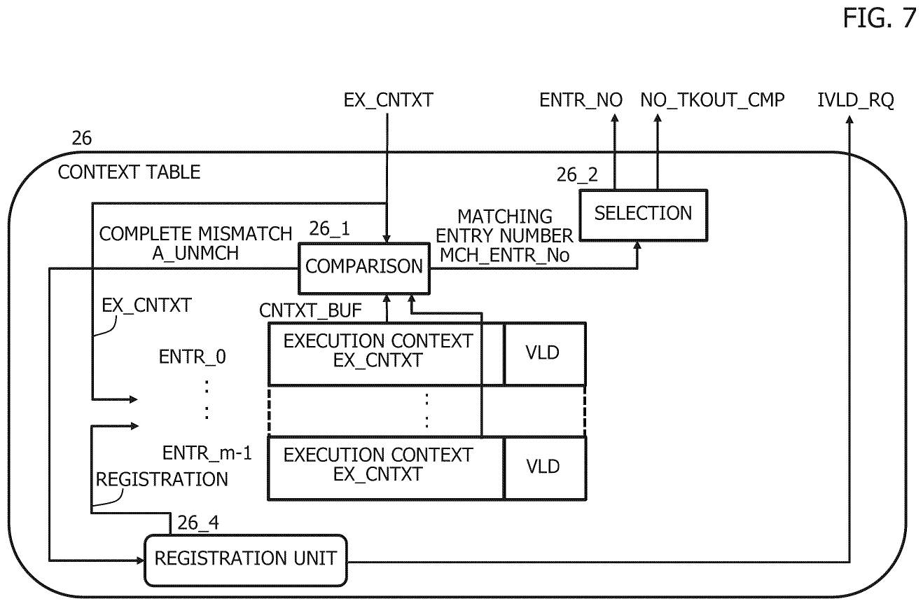

FIG. 7 is a diagram illustrating a configuration of a context table in a modification of the first embodiment. The context table 26 of FIG. 7 uses the entry numbers ENTR_0 to ENTR_m-1 in the context buffer CNTXT_BUF as the security IDs (SCR_ID). In the case of this modification, it is desirable that the registration unit 26_4 of the context table newly register the execution context EX_CNTXT after the switching in an entry in the order of entry numbers (ascending order or descending order) in response to the complete mismatch A_UNMCH from the selection circuit 26_2. In the case of newly registering in the order of entry numbers, when the execution context is newly registered in the following entry after one round of the entry number (entry number m-1 in the case of ascending order, entry number 0 in the case of descending order), the registration unit 26_4 outputs an invalidation request INVD_RQ to the branch prediction mechanism 24 to cause the branch prediction mechanism 24 to invalidate all entries in the branch prediction buffer. The following entry number after one round of the entry number may not be fixed to 0 in the case of the ascending order nor m-1 in the case of the descending order, but may be any registration order, such as registration to an arbitrary entry number and proceeding with registration to entries in the ascending order or the descending order.

According to the present modification, the number of bits of the entry in the context table 26 can be reduced, and the circuit resources of the context table can be suppressed. In the present modification, the instruction address and the entry number of the context table are registered in the tag of the entry of the branch prediction buffer in the branch prediction mechanism.

Other than the above, the operations of the context table and the branch prediction mechanism are similar to those of the first embodiment.

### Second Embodiment

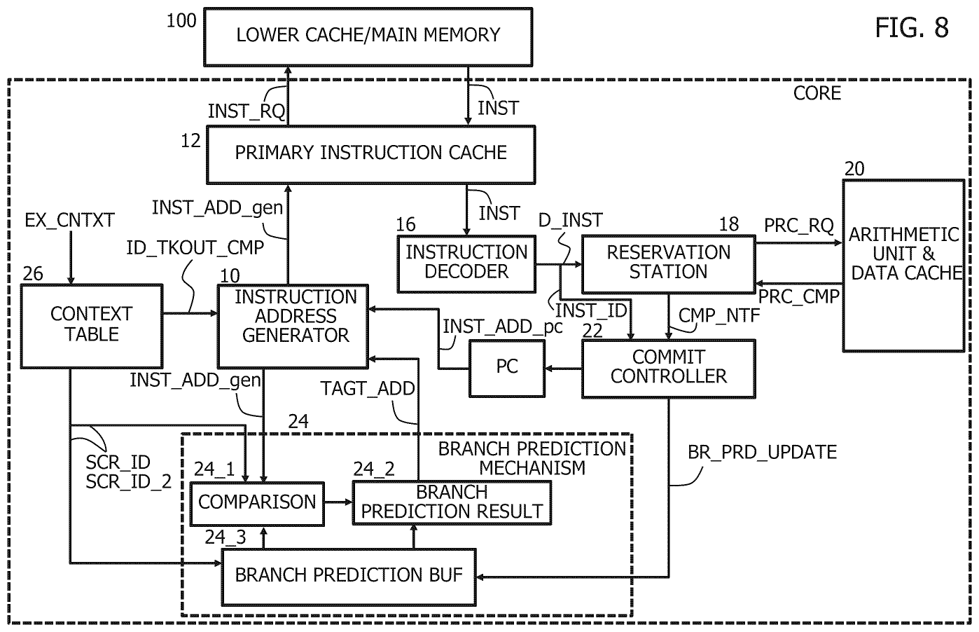

FIG. 8 is a diagram illustrating a configuration example of a core of a processor according to a second embodiment. The difference from the core configuration example of FIG. 3 is that the security ID associated with the execution context includes a second security ID2 (SCR_ID2) in addition to the first security ID (SCR_ID) that is same as in the first embodiment. Therefore, the execution context and the first security ID (SCR_ID) and the second security ID2 (SCR_ID2) associated with the execution context are stored in the entry of the context buffer of the context table 26. On the other hand, a hash value obtained by hashing the instruction address (or a part thereof) with the second security ID2 (SCR_ID2) and the first security ID (SCR_ID) are stored in the tag of the branch prediction buffer in the branch prediction mechanism 24.

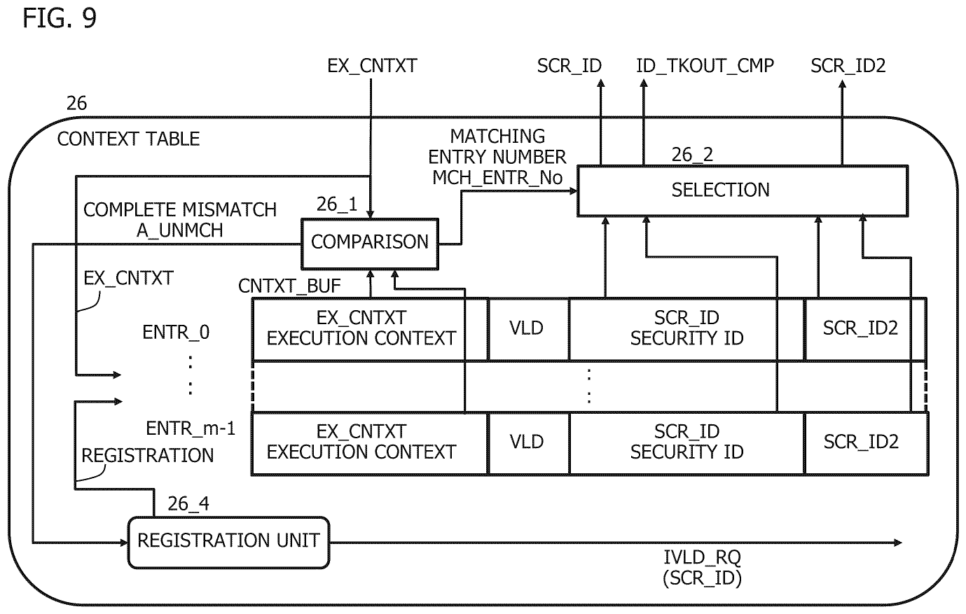

FIG. 9 is a diagram illustrating a first configuration example of the context table in the second embodiment. As illustrated in FIG. 9, in each entry in the context buffer, the execution context EX_CNTXT, the valid bit VLD, and, as security IDs having a small number of bits associated with the execution context, the first security ID (SCR_ID) and the second security ID2 (SCR_ID2) are registered. The second security ID2 (SCR_ID2) is preferably generated randomly. However, the second security ID2 (SCR_ID2) may be generated by simple addition and subtraction, or may be generated in ascending or descending order.

However, since the tag of the branch prediction buffer stores the hash generated by performing the hash operation on the instruction address (or a part thereof) with the second security ID2 (SCR_ID2), there is no increase in the number of bits of the tag, and there is no increase in the circuit scale of the buffer of the branch prediction mechanism as compared with the first embodiment.

In the second embodiment, by randomly generating the second security ID2 and randomly allocating the first and second security IDs (combinations of SCR_ID and SCR_ID2), it is possible to make it unnecessary to issue an invalidation request INVD_RQ to be transmitted to the branch prediction mechanism. That is, even if a malicious program can generate a security ID matching the first security ID (SCR_ID) generated in ascending or descending order, it is practically impossible to generate a security ID matching the second security ID2 (SCR_ID2) generated at random. As such, there is substantially no need to invalidate entries of the TAG of the branch prediction mechanism. In a case where only the first security ID (SCR_ID) is allocated in ascending or descending order, the TAG of the branch prediction mechanism can be hit if a malicious program is executed for the first security ID by the number of combinations of all bits. Therefore, it is necessary to invalidate the entry of the TAG of the branch prediction mechanism.

When the execution context EX_CNTXT after the switching is output from the system side, the context table 26 searches the context table with the execution context after the switching. When there is an entry storing the same execution context as the execution context after the switching and having the valid bit of VLD=1 (valid), the context table 26 extracts the first security ID (SCR_ID) and the second security ID2 (SCR_ID2) in the entry, and outputs the ID extraction completion flag ID_TKOUT_CMP to the instruction address generator 10.

When there is not the entry storing the same execution context as the execution context after the switching and having the valid bit of VLD=1 (valid), the context table newly registers the execution context after the switching and the first security ID (SCR_ID) and the second security ID2 (SCR_ID2) associated with the execution context after the switching in an entry. In this case, if there is an entry whose valid bit is VLD=0 (invalid), the context table registers the execution context and the security IDs in the entry. If there is only an entry with a valid bit of VLD=1 (valid), the context table overwrites and registers the execution context and the security IDs in the one of the entries. Then, in the context table, the valid bit of the registered entry is set to VLD=1 (valid), and the first security ID (SCR_ID) and the second security ID2 (SCR_ID2) associated with the execution context are extracted.

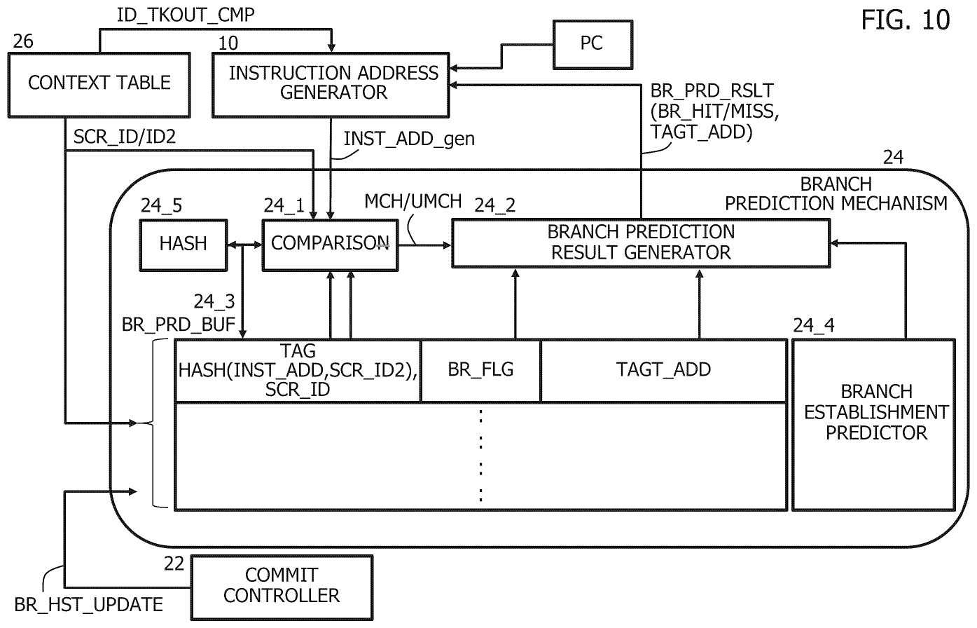

FIG. 10 is a diagram illustrating a configuration example of a branch prediction mechanism in the second embodiment. The hash HASH of the instruction address (or a part thereof) INST_ADD and the second security ID2 (SCR_ID2), and the first security ID (SCR_ID) are registered in the tag of the entry in the branch prediction buffer BR_PRD_BUF. Therefore, a hash calculator 24_5 is provided. As the first embodiment of FIG. 5, the branch flag BR_FLG and the branch target address TAGT_ADD are registered in the entry, the comparator 24_1 and the branch establishment predictor 24_4 are included.

When the branch instruction is completed, the commit controller 22 sends the branch history update request BR_HST_UPDATE to the branch prediction mechanism 24 to register the branch history attached to the branch history update request in an entry in the branch prediction buffer. At this time, the hash calculator 24_5 in the branch prediction mechanism performs the hash operation on the instruction address (or a part thereof) of the executed branch instruction included in the branch history with the second security ID2 (SCR_ID2) extracted from the context table, the hash value HASH and the first security ID (SCR_ID) are registered in the tag of the entry, and the valid bit VLD is validated. The branch flag BR_FLG and the target address TAGT_ADD are also registered similarly to FIG. 5.

The instruction address INST_ADD_gen generated by the instruction address generator 10 is sent to the branch prediction mechanism 24, and the branch prediction mechanism predicts the following instruction address. At this time, the first and second security ID and ID2 (SCR_ID and SCR_ID2) associated with the execution context currently being executed extracted from the context table 26 are output to the branch prediction mechanism. The comparator 24_1 causes the hash calculator 24_5 to perform a hash operation on the instruction address (or a part thereof) INST_ADD_gen with the second security ID2 (SCR_ID2), and compares the hash value HASH and the first security ID (SCR_ID) with the tag of the entry of the branch prediction buffer.

When the comparison result is the mismatch UMCH, the branch prediction result generator 24_2 of the branch prediction mechanism returns the branch prediction result (including the branch miss BR_MISS) BR_PRD_RSULT to the instruction address generator 10. In response, the instruction address generator issues an instruction fetch to the primary instruction cache at the following instruction address of the current instruction address INST_ADD_gen.

On the other hand, when the comparison result is the match MCH, the branch prediction result generator 24_2 returns the branch prediction result (including the branch hit BR_HIT and the target address TAGT_ADD) BR_PRD_RSULT to the instruction address generator. In response, the instruction address generator performs an instruction fetch into the primary instruction cache by using the target address TAGT_ADD.

The context table 26 of FIG. 9 generates a first security ID (SCR_ID) and a second security ID2 (SCR_ID2) when newly registering an execution context. Moreover, since the number of bits of the hash of the instruction address (or a part thereof) and the second security ID2 (SCR_ID2) is equal to or less than the number of bits of the instruction address (or a part thereof), the number of bits of the tag of the branch prediction buffer of the branch prediction mechanism does not increase.

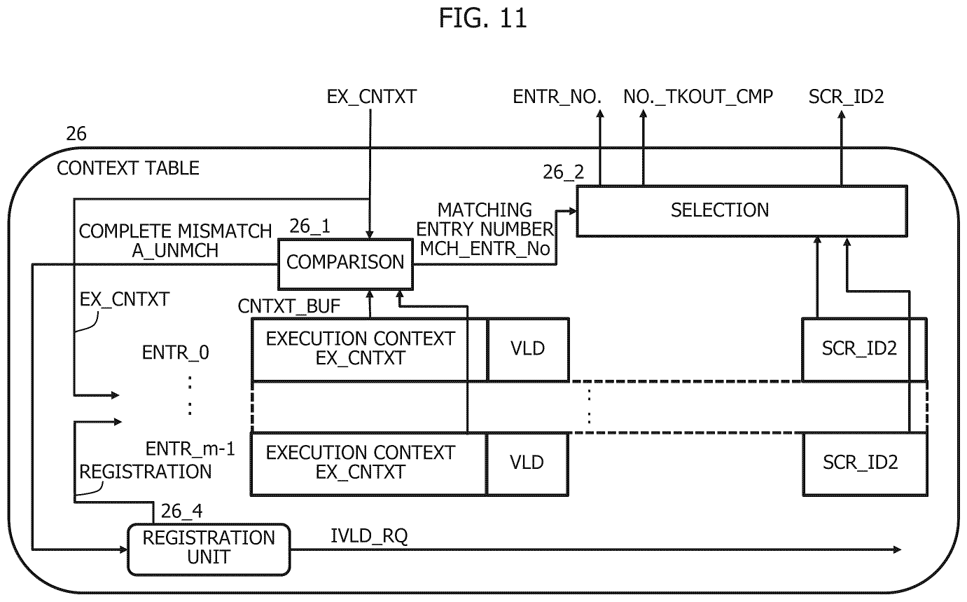

FIG. 11 is a diagram illustrating a modification of the context table in the second embodiment. The context table of FIG. 11 uses the entry numbers ENTR_0 to ENTR_m-1 of the context buffer as the first security ID. This modification corresponds to a modification of the first embodiment in FIG. 7.

Similarly to FIG. 7, in this modification, it is desirable that the registration unit 26_4 of the context table newly register the execution context EX_CNTXT after switching in the order of entry numbers (ascending order or descending order) in response to the complete mismatch A_UNMCH from the selection circuit 26_2. In the case of newly registering the entries in the order of entry numbers, when the entry number goes one round (m-1 in the case of ascending order, and 0 in the case of descending order), the registration unit 26_4 outputs an invalidation request INVD_RQ to the branch prediction mechanism 24 before newly registering the execution context in the following entry, and causes the branch prediction mechanism 24 to invalidate all entries in the branch prediction buffer.

Other than the above, the operations of the context table and the branch prediction mechanism are similar to those of the first embodiment.

According to the present modification, the number of bits of the entry in the context table 26 can be reduced, and the circuit resources of the context table can be suppressed. In the present modification, the hash of the instruction address (or a part thereof) and the second security ID2 (SCR_ID2) and the entry number ENTR_NO of the context table are registered in the tag of the entry of the branch prediction buffer in the branch prediction mechanism.

### Third Embodiment

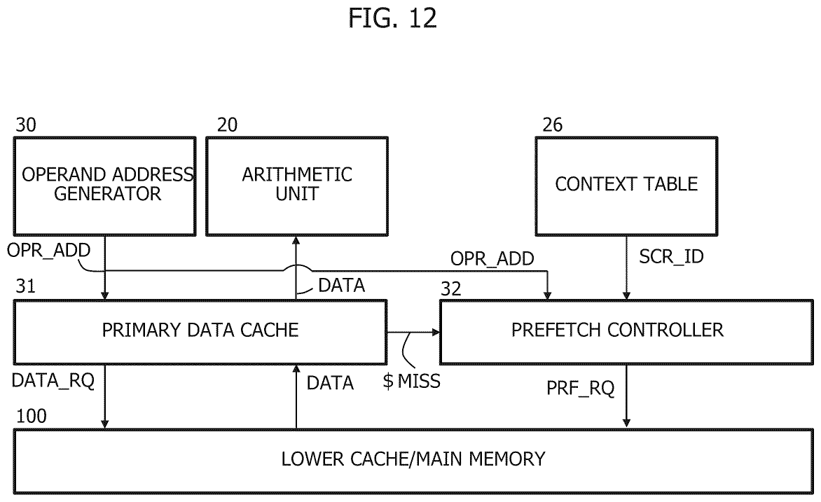

FIG. 12 is a diagram illustrating a configuration of a core of a processor according to a third embodiment. The core of FIG. 12 includes an arithmetic unit 20, a context table 26, a lower cache, and a main memory 100, which are also illustrated in FIG. 3. In addition, the core includes an operand address generator 30, a primary data cache 31, and a prefetch controller 32.

In the case of a memory access instruction, such as a load/store instruction, the decoded memory access instruction is sent to a reservation station, and the reservation station issues processing to the operand address generator 30. The operand address generator 30 issues a data request to the primary data cache 31 at the operand address of the memory access instruction to execute a data fetch. When a cache hit occurs in the primary data cache, the hit data is responded to the arithmetic unit 20. On the other hand, when the cache miss occurs, the data request issues a data request to the lower cache or main memory 100. Then, the data response from the lower cache or the main memory 100 is sent to the primary data cache 31 to register the data in the cache, and the data response is further sent from the primary data cache to the arithmetic unit 20. As a result, the arithmetic unit 20 stores the received data in a predetermined register and executes a subsequent operation instruction or the like for the data in the register.

When the memory access instruction consecutively accesses a plurality of addresses, the prefetch controller 32 prefetches data of addresses consecutive to the address at which the cache miss has occurred from the lower cache or the main memory 100, and registers the read data in the primary data cache in advance. As a result, the cache hit occurs in the primary data cache with respect to the data request of the memory access instruction executed thereafter, and the data response reaches the arithmetic unit 20 with a short latency.

The prefetching of data executed by the prefetch controller 32 is a memory access executed speculatively. Therefore, it is conceivable that a malicious program attempts to access data in a memory area whose access is prohibited using speculative memory access of the prefetch function. In the third embodiment, execution of speculative memory access by the prefetch controller is permitted only during execution of a normal program.

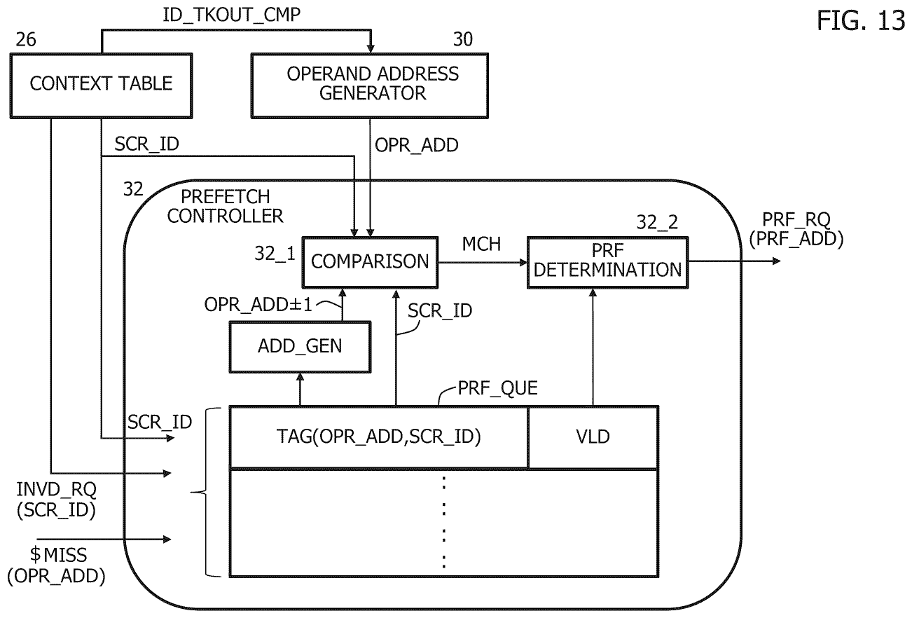

FIG. 13 is a diagram illustrating a configuration example of the prefetch controller 32 according to the present embodiment. The prefetch controller 32 includes a comparator 321, a prefetch determination unit 322, a prefetch queue PRF_QUE, and an address generator ADD_GEN. Briefly describing the operation of the prefetch controller 32, when the operand address generator 30 issues a data request to the primary data cache at the operand address OPR_ADD1 of a certain memory access instruction and a cache miss occurs, the operand address OPR_ADD1 at which the cache miss has occurred is stored in the tag of the entry of the prefetch queue PRF_QUE.

When the data access to the continuous address is performed, a cache miss occurs in the primary data cache also at the data request by the following prefetch address PRF_ADD2. The comparator 32_1 in the prefetch controller 32 determines whether the second prefetch address PRF_ADD2 is address in the positive direction (+1) or address in the negative direction (−1) with respect to the first prefetch address PRF_ADD1 being registered in the tag of the prefetch queue PRF_QUE. In the example of FIG. 13, the address generator ADD_GEN generates an address ADD1+1 of +1 and an address ADD1−1 of −1 with respect to the first operand address OPR_ADD1 being registered in the tag, and the comparator 321 compares the operand address OPR_ADD output by the operand address generator 30 with each of the addresses ADD1+1 and ADD1−1 generated by the address generator. When the address ADD1+1 is matched, it is determined that the data access is the access to the address in ascending order, and when the address ADD1−1 is matched, it is determined that the data access is the access to the address in descending order. Then, based on the determination result, the prefetch controller 32 updates the operand address OPR_ADD in the tag of the entry in the prefetch queue PRF_QUE to ADD1+1 or ADD1−1.

Based on the above determination, the prefetch determination unit 32_2 issues a prefetch request to the lower cache or the main memory at an address ADD1+2 in case of ascending order, and issues a prefetch request at an address ADD1−2 in case of descending order. This prefetch request is a type of speculative memory access. Then, since the prefetched data is registered in the primary data cache 31, when the operand address generator 30 subsequently issues a data request to the address of the prefetched data, a cache hit is necessarily made in the primary data cache, and the latency of the data fetch is shortened.

In the next cycle, since the updated operand address OPR_ADD in the prefetch queue PRF_QUE is ADD1+1 or ADD1−1, the comparator 32_1 determines whether the operand address OPR_ADD output by the operand address generator 30 matches the address ADD1+2 (or matches ADD1−2) in the operand queue. If the determination result is the match MCH, the prefetch determination unit 32_2 issues a prefetch request to the address ADD1+3 (or ADD1−3).

The malicious program registers a desired operand address in the tag of the prefetch queue PRF_QUE to attempt to access data, which is prohibited from being accessed, by a speculative prefetch request during execution of the regular program.

Therefore, the core of the processor of the third embodiment has a context table 26, stores an execution context provided from the system side at the start of execution of a certain program in an entry in the context table in association with a security ID capable of identifying the execution context, extracts the security ID, and enables the security ID extraction completion flag ID_TKOUT_CMP, similarly to FIG. 4.

On the other hand, when a cache miss occurs in the primary data cache for the data request issued by the operand address generator, a cache miss $MISS is transmitted to the prefetch controller 32 together with the operand address OPR_ADD at which the cache miss has occurred, and the prefetch controller 32 registers the operand address OPR_ADD together with the security ID (SCR_ID) being extracted from the context table in the tag of the entry in the prefetch queue PRF_QUE in response to the cache miss.

Then, when the operand address generator 30 issues a data request with a certain operand address, the comparator 32_1 and the prefetch determination unit 32_2 of the prefetch controller 32 perform the prefetch control described above and speculatively execute the prefetch request PRF_RQ.

As in the first embodiment, when the context table issues an invalidation request INVD_RQ (with or without a security ID) when the context table newly registers the execution context to a valid entry in the context buffer, the prefetch controller invalidates at least an entry that stores the same security ID as the security ID of the invalid request in the prefetch queue PRR_QUE, or invalidates all entries in the prefetch queue.

The context table of the third embodiment may have any of the configurations illustrated in FIGS. 4, 7, 9, and 11. The tag information of the entry of the prefetch queue in the prefetch controller is also equivalent to the example described above corresponding to the configuration of the context table in FIGS. 4, 7, 9, and 11.

According to the above embodiments, the execution context and the security ID having a small number of bits associated with the execution context are stored in the context table, and the address and the security ID are stored in the tag of the entry in the branch prediction buffer of the branch prediction mechanism or in the tag of the entry in the prefetch queue of the prefetch controller. As a result, it is possible to distinguish between the entry registered by the authorized program and the entry registered by the malicious program in the branch prediction by the branch prediction mechanism, and it is possible to further suppress the circuit scale of the branch prediction buffer. In the prefetch determination by the prefetch controller, it is possible to distinguish between an entry registered by an authorized program and an entry registered by a malicious program, and it is possible to further suppress the circuit scale of the prefetch queue.

According to the above embodiments, the number of bits of the security ID is small, and the number of security IDs that can be registered in the context table is small. Therefore, when a new execution context and a security ID thereof are overwritten in the context table, at least an entry that stores the security ID before being overwritten among entries of buffers in the branch prediction mechanism and the prefetch controller is invalidated. As a result, the entry registered by the authorized program and the entry registered by the malicious program are reliably distinguished.

According to the first aspect, vulnerability is suppressed while increase in the circuit scale of the branch prediction mechanism and the prefetch controller is suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention

What is claimed is:

1. A microprocessor comprising:
an instruction address generator that generates an instruction address that is a fetch destination of an instruction and outputs the instruction address to execute an instruction fetch;
a context table that includes a context buffer including M first entries that respectively store an execution context associated with a process in association with a security ID capable of identifying the execution context, and extracts the security ID associated with the execution context of the process being executed; and
a branch prediction mechanism that includes a branch prediction buffer including N second entries that respectively store
a tag that stores a branch instruction address of a branch instruction executed in the past and the security ID when the branch instruction was executed, and
a branch target address of the branch instruction executed in the past, N being greater than M, and M and N being natural numbers greater than or equal to 2,
the branch prediction mechanism
comparing the instruction address output by the instruction address generator and the security ID extracted from the context table with the branch instruction address and the security ID in the tag of the N second entries, and
outputting the branch target address in the N second entries matched in the comparison to the instruction address generator,
wherein the instruction address generator executes the instruction fetch based on the branch target address output from the branch prediction mechanism.

2. The microprocessor according to claim 1, wherein
the context table
searches, when the execution context is switched, the M first entries with the switched execution context,
in a case where the switched execution context is registered in any of the M first entries, extracts the security ID in the entry of the M first entries that registers,
in a case where the registration has not been performed and there is an invalid entry in the M first entries, registers the switched execution context and a security ID for identifying the switched execution context in the invalid entry of the M first entries and extracts the registered security ID, and
in a case where the registration has not been performed and there is no invalid entry in the M first entries, overwrites and registers the switched execution context and a security ID for identifying the switched execution context in an entry of the M first entries and transmits an invalidation request to the branch prediction mechanism, and
the branch prediction mechanism invalidates at least the second entry storing the original security ID that has been overwritten and registered in response to the invalidation request.

3. The microprocessor according to claim 2, wherein
the context table
updates the security ID in ascending or descending order and overwrites and registers the updated security ID being associated with the switched execution context in the entry of the M first entries, when overwriting and registering the security ID in the entry of the M first entries, and
transmits an invalidation request for invalidating all of the N second entries to the branch prediction mechanism when the update of the security ID has made one round, and
the branch prediction mechanism invalidates all of the N second entries in response to the invalidation request.

4. The microprocessor according to claim 3, wherein
the security ID is an entry number of the M first entries, and
the context table updates the entry number of the M first entries in ascending or descending order as the security ID when overwriting and registering the security ID in the M first entries.

5. The microprocessor according to claim 1, wherein
the context table further stores an additional security ID associated with the execution context in each of the M first entries, and
the branch prediction mechanism stores a hash of the instruction address and the additional security ID, and the security ID in a tag of each of the N second entries.

6. The microprocessor according to claim 5, wherein
the context table
searches, when the execution context is switched, the M first entries with the switched execution context,
in a case where the switched execution context is registered in any of the M first entries, extracts the security ID and an additional security ID in the entry of the M first entries that registers,
in a case where the registration has not been performed and there is an invalid entry in the M first entries, registers the switched execution context, and a security ID and an additional security ID for identifying the switched execution context in the invalid entry of the M first entries and extracts the registered security ID and additional security ID, and
in a case where the registration has not been performed and there is no invalid entry in the M first entries, overwrites and registers the switched execution context, and a security ID and an additional security ID for identifying the switched execution context in an entry of the M first entries.

7. The microprocessor according to claim 1, wherein the number of bits of the security ID is smaller than the number of bits of the execution context and a program ID that identifies the process included in the execution context.

8. A microprocessor comprising:
an operand address generator that generates an operand address that is a fetch destination of data and outputs the operand address to execute a data fetch;
a context table that includes a context buffer including M first entries that respectively store an execution context associated with a process in association with a security ID capable of identifying the execution context, and extracts the security ID associated with the execution context of the process being executed; and
a prefetch controller that includes a prefetch queue including N second entries that respectively store an operand address when a cache miss occurs in a primary data cache in response to a data request for fetching data and the security ID when the data request is executed, N being greater than M and M and N being natural numbers greater than or equal to 2,
the prefetch controller
compares the operand address output by the operand address generator and the security ID extracted from the context table with a pair of operand addresses adjacent to the operand address and the security ID in the N second entries, and
executes data prefetching to a cache lower than the primary data cache or a main memory based on the operand address matched in the comparison between the pair of operand addresses.

9. A processing method of a microprocessor, the method comprising:
wherein the microprocessor includes
an instruction address generator that generates an instruction address that is a fetch destination of an instruction and outputs the instruction address to execute an instruction fetch;
a context table that includes a context buffer including M first entries that respectively store an execution context associated with a process in association with a security ID capable of identifying the execution context, and extracts the security ID associated with the execution context of the process being executed; and
a branch prediction mechanism that includes a branch prediction buffer including N second entries,
wherein N is greater than M and M and N are natural numbers greater than or equal to 2,
by the branch prediction mechanism,
storing, in each of the N second entries, a tag that stores a branch instruction address of a branch instruction executed in the past and the security ID when the branch instruction was executed, and a branch target address of the branch instruction executed in the past;
comparing the instruction address output by the instruction address generator and the security ID extracted from the context table processor with the branch instruction address and the security ID in the tag of the N second entries; and
outputting the branch target address in the N second entries matched in the comparison to the instruction address generator, and
by the instruction address generator, executing the instruction fetch based on the branch target address output from the branch prediction mechanism.

10. A processing method of a microprocessor, the method comprising:
wherein the microprocessor includes
an operand address generator that generates an operand address that is a fetch destination of data and outputs the operand address to execute a data fetch;
a context table that includes a context buffer including M first entries that respectively store an execution context associated with a process in association with a security ID capable of identifying the execution context, and extracts the security ID associated with the execution context of the process being executed; and
a prefetch controller that includes a prefetch queue including N second entries,
wherein N is greater than M, and M and N are natural numbers greater than or equal to 2, and
by the prefetch controller,
storing, in each of the N second entries, an operand address when a cache miss occurs in a primary data cache in response to a data request for fetching data and the security ID when the data request is executed,
comparing the operand address output by the operand address generator and the security ID extracted from the context table processor with a pair of operand addresses adjacent to the operand address and the security ID in the N second entries, and
executing data prefetching to a cache lower than the primary data cache or a main memory based on the operand address matched in the comparison between the pair of operand addresses.
